(19) United States
(12) Patent Application Publication
(10) Pub. No.: US 2005/0177679 A1
(43) Pub. Date: Aug. 11, 2005

(54) Semiconductor memory device

(76) Inventors: Mauricio Huerta Alva, Boise, ID (US); Kenneth K. Smith, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/773,708

(22) Filed: Feb. 6, 2004

(51) Int. Cl. G06F 12/08

(52) U.S. Cl. 711/104; 711/203; 711/105; 711/118

(57) ABSTRACT

A memory device comprises a magneto-resistive random access memory (MRAM), a cache comprising a volatile memory, and a decoder configured to translate referenced addresses to physical addresses to access data and pass the data between the MRAM and the cache and between the cache and a controller.

### BACKGROUND

Most modern computer systems typically include a central processing unit (CPU) and a main memory. The speed at which the CPU can decode and execute instructions and operands depends upon the rate at which the instructions and operands can be transferred from main memory to the CPU. In an attempt to reduce the time required for the CPU to obtain instructions and operands from main memory, many computer systems typically include a cache memory between the CPU and main memory.

A cache memory is typically a small, high-speed buffer memory that is used to temporarily hold those portions of the contents of main memory that are anticipated will be used in the near future by the CPU. The main purpose of a cache memory is to shorten the time necessary to perform memory accesses, either for data or instructions. The information located in cache memory may be accessed in much less time than information located in main memory. Thus, a CPU with a cache memory may spend far less time waiting for instructions and data to be fetched and/or stored.

### SUMMARY

In one exemplary embodiment, the present disclosure provides a memory device. The memory device comprises a magneto-resistive random access memory (MRAM), a cache comprising a volatile memory, and a decoder configured to translate referenced addresses to physical addresses to access data and pass the data between the MRAM and the cache and between the cache and a controller.

### BRIEF DESCRIPTION OF THE DRAWINGS

Exemplary embodiments of the invention are better understood with reference to the following drawings. The elements of the drawings are not necessarily to scale relative to each other. Like reference numerals designate corresponding similar parts.

FIG. 1 is a block diagram illustrating an exemplary embodiment of a cache assisted magneto-resistive random access memory (MRAM) device with a controller.

FIG. 2 is a block diagram illustrating an exemplary embodiment of a segmented cache.

FIG. 3 is a diagram illustrating an exemplary embodiment of an MRAM.

FIG. 4 is a diagram illustrating an exemplary embodiment of an MRAM array section.

FIG. 5 is a diagram illustrating a cross section of an exemplary embodiment of an MRAM array section.

FIG. 6 is a diagram illustrating an exemplary embodiment of a hand held portable electronic device including a cache assisted MRAM device.

FIG. 7 is a block diagram illustrating an exemplary embodiment of an MRAM virtual memory system.

FIG. 8 is a flow diagram illustrating an exemplary embodiment of a method for reading or writing information in an MRAM virtual memory system.

### DETAILED DESCRIPTION

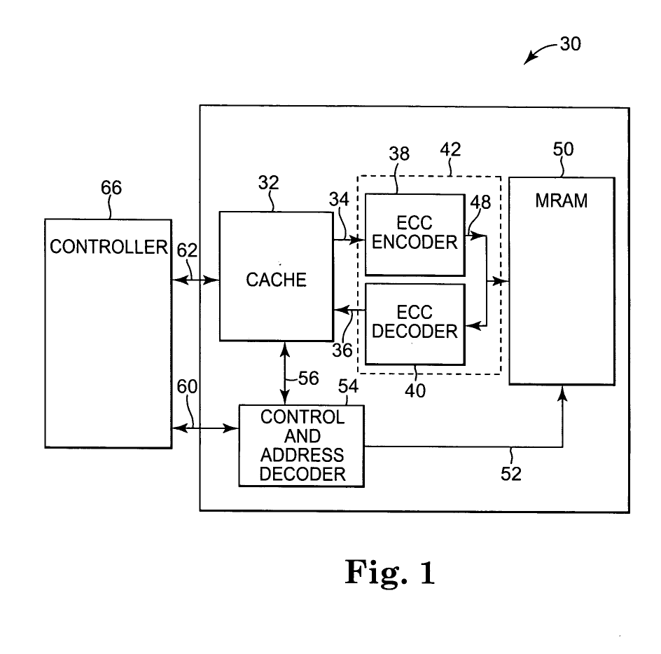

FIG. 1 is a block diagram illustrating an exemplary embodiment of a cache assisted magneto-resistive random access memory (MRAM) device 30 with a controller 66. Memory device 30 comprises a cache 32, a control and address decoder 54, an error detection and correction (ECC) circuit 42, and an MRAM 50. ECC circuit 42 includes ECC encoder 38 and ECC decoder 40. Cache 32 is electrically coupled to ECC encoder 38 through path 34 and to ECC decoder 40 through path 36. MRAM 50 is electrically coupled to ECC encoder 38 and ECC decoder 40 through path 48. MRAM 50 is electrically coupled to control and address decoder 54 through path 52. Control and address decoder 54 is electrically coupled to cache 32 through path 56. Controller 66 is electrically coupled to control and address decoder 54 through path 60 and to cache 32 through path 62.

Controller 66 is a central processing unit (CPU), microprocessor, microcontroller, or other suitable controller for use in an electronic device that uses memory such as a personal computer (PC), laptop computer, tablet computer, internet appliance, personal digital assistant (PDA), electronic organizer, cellular telephone, video game system, digital camera, digital music player, etc. Controller 66 communicates reference addresses to control and address decoder 54 through path 60 and sends data to and receives data from cache 32 through path 62.

Control and address decoder 54 controls the passing of data between MRAM 50 and cache 32. Control and address decoder 54 includes electronics for the control of the various components of magnetic memory device 30. Control and address decoder 54 executes control over cache 32, ECC circuit 42 and MRAM 50. Control and address decoder 54 translates referenced addresses from controller 66 to physical addresses in MRAM 50 and cache 32.

MRAM 50 includes a plurality of magnetic memory cells arranged in one or more arrays. A memory cell typically includes a layer of magnetic film in which the magnetization of the magnetic film is alterable and a layer of magnetic film in which the magnetization is fixed or pinned in a particular direction. The magnetic film having alterable magnetization is referred to as a sense layer, and the magnetic film that is pinned is referred to as a reference layer.

A memory cell is written to a logic state by applying magnetic fields that rotate the orientation of magnetization in the sense layer. The logic state of a memory cell is indicated by the resistance through the memory cell, which depends on the relative orientations of magnetization in the sense layer and reference layer.

Cache 32 is a unified cache and is a volatile memory that is free of defects. In one embodiment, cache 32 is a segmented cache, which includes a segment for storing data and a segment for storing instructions. Cache 32 comprises static random access memory (SRAM), dynamic random access memory (DRAM), or other suitable memory that is free of defects and has a significantly faster access time than MRAM 50.

Cache 32 is a small buffer memory, which has a significantly faster access time than MRAM 50, that is used to temporarily hold those portions of the contents of MRAM 50 that are anticipated will be used in the near future by controller 66. Cache 32 may shorten the time necessary for controller 66 to perform memory accesses, either for data or instructions. The information located in cache 32 can be accessed in less time than information located in MRAM 50. Thus, controller 66 accessing cache 32 may spend less time waiting for instructions and data to be fetched and/or stored.

Cache 32 is made up of many blocks of one or more words of data and instructions retrieved from MRAM 50. Each block has associated with it an address tag and other information that uniquely identifies the block of RAM 50 of which it is a copy.

In order to reduce the cost of manufacture, MRAM circuits may be built with a limited number of defects remaining in the memory array. These defects would normally cause the memory locations to be unusable. However, when ECC circuit 42 is used with MRAM 50, all segments of the memory array can be used.

ECC circuit 42 provides error detection and correction algorithms. These algorithms may include a parity encoding, BCH ECC algorithm, or Reed-Solomon ECC algorithm. Redundant or parity information is stored in MRAM 50 along with the data. This redundant information associated with a line of data is utilized to determine if an error has occurred in the data line and to then correct the erroneous bit or bits of information. ECC circuit 42 may provide anywhere from single bit error correction to multiple symbol error correction depending on the selected algorithm. Simple parity codes have little overhead, but can only detect single-bit errors. BCH and Reed-Solomon codes have more overhead, but provide the benefit of being able to correct one or more bits or symbols of information.

ECC encoder 38 encodes data received from cache 32 (thereby creating redundancy information) before the data and redundancy information is stored in MRAM 50. ECC decoder 40 decodes ECC encoded data retrieved from MRAM 50 before the data is passed to cache 32.

Each time controller 66 makes a memory reference, control and address decoder 54 performs an address tag comparison to determine if a copy of the requested data or instructions resides in and is valid within cache 32. If the desired data line is not in cache 32 or is invalid, control and address decoder 54 retrieves the data line from MRAM 50. The data line is decoded by ECC decoder 40, stored in cache 32, and supplied to controller 66 through path 62. In one embodiment, the address tag is a subset of the address bits. For example, if controller 66 uses 32 address bits, the tag can consist of the upper 12 bits. A valid bit is also stored with the cached information to indicate whether the line in the cache is currently valid.

In addition to using cache 32 to retrieve data from magnetic memory 32, controller 66 also writes data into cache 32 instead of directly into MRAM 50. A data “dirty bit” for the data line is stored in cache 32 along with the data line. When cache 32 is set in “copyback” mode, data is not written directly to MRAM 50 whenever cache 32 is written. Instead, when cache 32 is written, the dirty bit for that line is set. This write to cache 32 can take place when a read request from control and address decoder 54 is requesting use of the storage location of the dirty information. Optionally, control and address decoder 54 can directly request that a specific line or all lines that are currently dirty in cache 32 be written to MRAM 50. The dirty bit indicates that data in the data line is dirty (i.e., has been modified), and thus before the data line is overwritten, it must be passed to MRAM 50. In the event that the specified location is to be overwritten, and the dirty bit is set, ECC encoder 38 is passed the line from cache 32 and redundancy information is created. The line and redundancy information are both written into MRAM 50.

Alternatively, cache 32 can be set into “write-through” mode. In this mode of operation, whenever a write is attempted into cache 32, the same data is passed through ECC encoder 38 and out to MRAM 50. The write-through mode has the advantage that in the event of a power failure, MRAM 50 contains a complete set of information that is available after the power is restored.

During normal operation, there are several different actions that may be used to satisfy some memory reference. A memory reference may be a load or store instruction. First, simplest, and fastest, the reference might hit in cache 32 and the valid bit is “1”. A hit occurs when the data for a desired memory address is present in cache 32. A miss occurs when the data for a desired memory address is not present in cache 32 or its valid bit is “0”.

The slowest operation is when the memory reference misses cache 32. In this instance, control and address decoder 54 translates reference addresses to physical addresses. Control and address decoder 54 reads the data in MRAM 50 from the physical addresses and passes the data to ECC decoder 40. ECC decoder 40 decodes the data and passes the data to cache 32. Cache 32 is again referenced, resulting, this time, in a hit and the requested data is supplied to controller 66, or the store operation completes. An alternative to this is to have ECC decoder 40 pass the information directly to path 62 for controller 66.

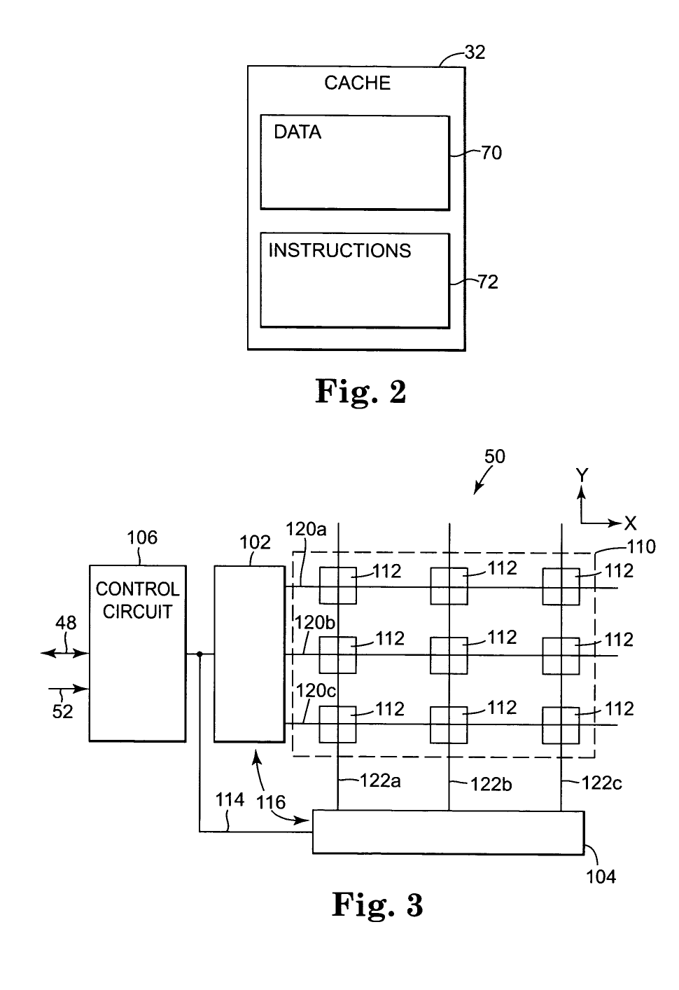

FIG. 2 is a block diagram illustrating an exemplary embodiment of cache 32. In this embodiment, cache 32 is a segmented cache. Cache 32 includes data segment 70 and instructions segment 72. In other embodiments, the number of segments of cache 32 is configurable.

Data segment 70 is a high-speed buffer memory that is used to temporarily hold data stored in MRAM 50 that is anticipated will be used in the near future by controller 66. The data that is anticipated will be used in the near future includes data sequentially following data stored in MRAM 50 that has been recently requested. Data segment 70 may shorten the time necessary to perform memory accesses, either for data read or write operations. The data located in data segment 70 may be accessed in less time than data located in MRAM 50. Thus, controller 66 accessing data segment 70 may spend less time waiting for data to be fetched and/or stored.

Data segment 70 is made up of many blocks of one or more words of data retrieved from MRAM 50. Each block has associated with it an address tag and other information that uniquely identifies the block of MRAM 50 of which it is a copy.

Instructions segment 72 is a high-speed buffer memory that is used to temporarily hold instructions stored in MRAM 50 that are anticipated will be used in the near future by controller 66. The instructions that are anticipated will be used in the near future includes instructions sequentially following instructions stored in MRAM 50 that have been recently requested. Instructions segment 72 may shorten the time necessary to perform memory accesses for reading or writing instructions. The instructions located in instructions segment 72 may be accessed in less time than instructions located in MRAM 50. Thus, controller 66 accessing instructions segment 72 may spend less time waiting for instructions to be fetched.

Instructions segment 72 is made up of many blocks of one or more words of instructions retrieved from MRAM 50. Each block has associated with it an address tag and other information that uniquely identifies the block of MRAM 50 of which it is a copy.

FIG. 3 is a diagram illustrating an exemplary embodiment of MRAM 50. MRAM 50 includes a control circuit 106, a read/write circuit 116, and an MRAM array 110. Read/write circuit 116 includes a row circuit 102 and a column circuit 104. MRAM array 110 includes memory cells 112.

Row circuit 102 and column circuit 104 are used to read and write data to the memory cells 112. Row circuit 102 is electrically coupled to word lines 120a-120c and column circuit 104 is electrically coupled to bit lines 122a-122c. Control circuit 106 is electrically coupled to row circuit 102 and column circuit 104 through conductive read/write paths 114. Control circuit 106 is electrically coupled to ECC Encoder 38 and ECC Decoder 40 through path 48 and to control and address decoder 54 through path 52.

The memory cells 112 are arranged in rows and columns, with the rows extending along an x-direction and the columns extending along a y-direction. Only a relatively small number of memory cells 112 are shown to simplify the illustration. In practice, the array 110 can be any suitable size and can utilize highly parallel modes of operation, such as 64-bit wide or 128-bit wide operation.

In the exemplary embodiment, word lines 120a-120c extend along the x-direction in a plane on one side of array 110 and bit lines 122a-122c extend along the y-direction in a plane on an adjacent side of array 110. There is one word line 120a-120c for each row of array 110 and one bit line 122a-122c for each column of array 110. A memory cell 112 is located at each intersection or cross-point of a word line 120a-120c and a bit line 122a-122c.

The memory cells 112 are not limited to any particular type of device. Memory cells 112 may be, for example, spin dependent tunneling junction devices, anisotropic magnetoresistive devices, giant magnetoresistive devices, colossal magnetoresistive devices, extraordinary magnetoresistive devices, or very large magnetoresistive devices.

Control circuit 106 includes circuits for communicating with ECC encoder 38, ECC decoder 40, control and address decoder 54, and read/write circuit 116. In the exemplary embodiment, control circuit 106, read/write circuit 116, and array 110 are formed on the same silicon substrate.

Control circuit 106 controls read/write circuit 116 to write data into array 110 and read data from array 110. Control circuit 106 receives write commands and write addresses from control and address decoder 54 through path 52 and receives data from ECC encoder 38 through path 48. Control circuit 106 receives read commands and read addresses from control and address decoder 54 and transmits data to ECC decoder 40 through path 48.

Read/write circuit 116 provides write currents through word lines 120a-120c and bit lines 122a-122c to write memory cells 112 in array 110. To write a selected memory cell 112, row circuit 102 provides a first write current through a selected word line 120a-120c and column circuit 104 provides a second write current through a selected bit line 122a-122c. Row circuit 102 can provide the first write current through the selected word line 120a-120c in either direction as needed for writing the selected memory cell 112. Column circuit 104 can provide the second write current through the selected bit line 122a-122c in either direction as needed to write the selected memory cell 112. One read/write circuit 116 is illustrated as coupled to array 110. In practice, any suitable number of read/write circuits can be coupled to array 110. In addition, array 110 can include any suitable number of memory cells 112. The memory cells 112 in array 110 can be written to and read from in highly parallel modes.

Row circuit 102 selects one word line 120a-120c and column circuit 104 selects one bit line 122a- 122c to set or switch the orientation of magnetization in the sense layer of the memory cell 112 located at the cross-point of the selected word line 120a-120c and bit line 122a-122c. Row circuit 102 provides the first write current to the selected word line 120a-120c and column circuit 104 provides the second write current to the selected bit line 122a-122c. The first write current creates a magnetic field around the selected word line 120a-120c, according to the right hand rule, and the second write current creates a magnetic field around the selected bit line 122a-122c, according to the right hand rule. The magnetic fields combine to set or switch the orientation of magnetization in the sense layer of the selected memory cell 112.

To read data from array 110, read/write circuit 116 selects one word line 120a-120c and one bit line 122a-122c to sense the resistance through the memory cell 112 located at the cross-point of the selected word line 120a-120c and bit line 122a-122c. Row circuit 102 selects a word line 120a-120c and column circuit 104 selects a bit line 122a-122c. Row circuit 102 electrically couples the selected word line 120a-120c to ground. Column circuit 104 provides a constant sense voltage on the selected bit line 122a-122c to produce a sense current through the selected memory cell 112. The magnitude of the sense current through the selected memory cell 112 corresponds to the resistive state and the logic state of the selected memory cell 112. Column circuit 104 senses the magnitude of the sense current and provides a logic output signal to control circuit 106. The logic output signal is a high or low logic level indicating the resistive state of the selected memory cell 112.

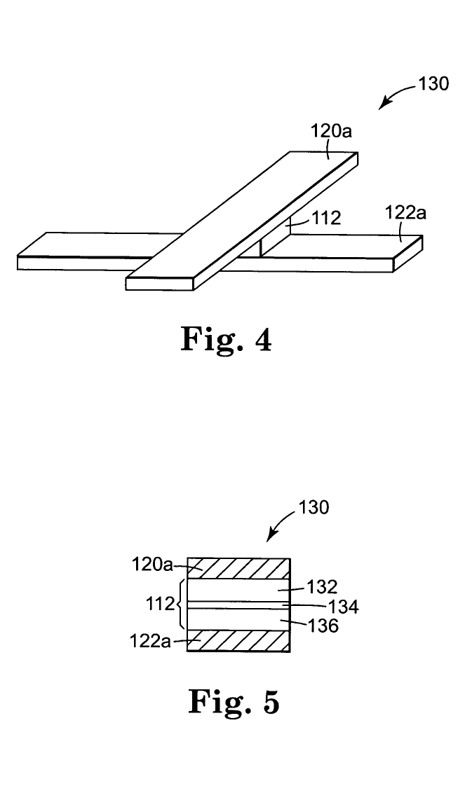

FIG. 4 is a diagram illustrating an exemplary embodiment of an array section 130. Array section 130 includes word line 120a, a memory cell 112, and bit line 122a. Memory cell 112 is located between word line 120a and bit line 122a. In the exemplary embodiment, word line 120a and bit line 122a are orthogonal to one another. In other embodiments, word line 120a and bit line 122a can lie in other suitable angular relationships to one another.

In the exemplary embodiment, word line 120a and bit line 122a are electrically coupled to read/write circuit 116. Read/write circuit 116 provides write currents to word line 120a and bit line 122a to create magnetic fields, according to the right hand rule, around word line 120a and bit line 122a, and in memory cell 112. The magnetic fields combine to set or switch the state of memory cell 112.

FIG. 5 is a diagram illustrating a cross section of the exemplary embodiment of array section 130. The array section 130 includes memory cell 112 located between word line 120a and bit line 122a. Memory cell 112 includes a sense layer 132, a spacer layer 134, and a reference layer 136. The spacer layer 134 is located between sense layer 132 and reference layer 136. Sense layer 132 is located next to word line 120a, and reference layer 136 is located next to bit line 122a. Sense layer 132 has an alterable orientation of magnetization and reference layer 136 has a pinned orientation of magnetization.

In the exemplary embodiment, memory cell 112 is an MTJ, spin tunneling device with spacer layer 134 being an insulating barrier layer through which an electrical charge tunnels during read operations. Electrical charge tunneling through spacer layer 134 occurs in response to a voltage applied across memory cell 112. In an alternative embodiment, a GMR structure can be used for memory cell 112 with spacer layer 134 being a conductor, such as copper.

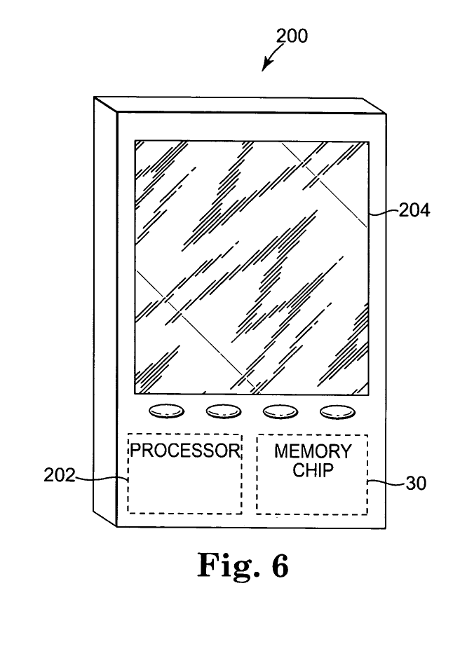

FIG. 6 is a diagram illustrating an exemplary embodiment of a hand held portable electronic device 200 incorporating the cache assisted MRAM device 30. In this embodiment, hand held portable electronic device 200 is a personal digital assistant (PDA). In other embodiments, hand held portable electronic device 200 can be a cellular telephone, a digital music player, a personal organizer, a digital camera, or other hand held portable electronic device.

Hand held portable electronic device 200 includes a processor 202, the cache assisted MRAM device 30, and a display 204. Processor 202 is electrically coupled to MRAM device 30. MRAM device 30 stores data and instructions used by processor 202 to control PDA 200, including display 204.

A combination of a plurality of memory technologies is typically used for main memory and cache in portable electronic devices, such as one time programmable memory (OTP), static random access memory (SRAM), dynamic random access memory (DRAM), Flash memory, etc. These different memory devices are typically provided on separate semiconductor substrates and then combined. Cache-assisted MRAM device 30 may be provided on a single substrate and may be a single semiconductor chip. The chip may provide a cache and main memory solution that has reduced complexity and cost in comparison to the multi-substrate solutions. In addition, memory chip 30 may provide a more compact package than the multi-substrate solutions.

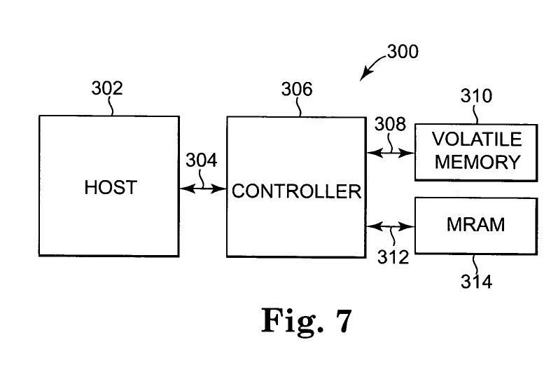

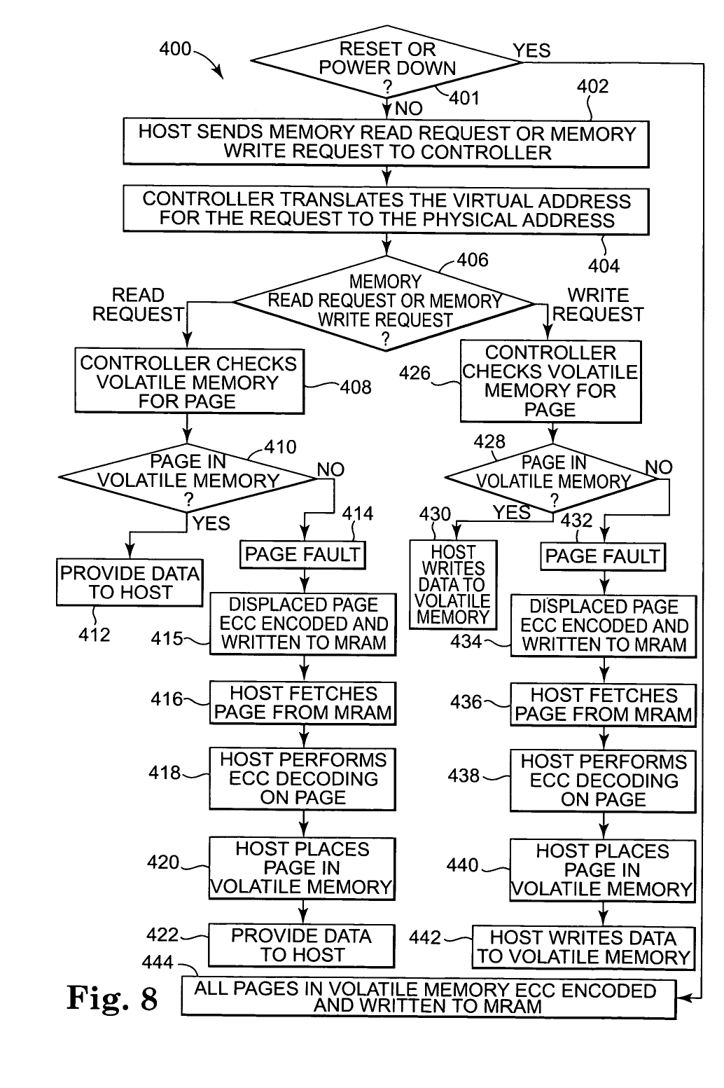

FIG. 7 is a block diagram illustrating an exemplary embodiment of an MRAM virtual memory system 300. MRAM virtual memory system 300 includes host 302, controller 306, volatile memory 310, and MRAM 314. Host 302 is electrically coupled to controller 306 through path 304. Controller 306 is electrically coupled to volatile memory 310 through path 308 and to MRAM 314 through path 312.

Host 302 is an electronic device that uses memory such as a personal computer (PC), laptop computer, tablet computer, internet appliance, personal digital assistant (PDA), electronic organizer, cellular telephone, video game system, digital camera, digital music player, etc. Host 302 communicates reference addresses to controller 306 through path 304 and sends data to and receives data from volatile memory 310 and MRAM 314 through controller 306 and path 304.

Controller 306 controls the passing of data between MRAM 314 and volatile memory 310. Controller 306 includes both electronics and firmware for the control of the various components of MRAM 314 and volatile memory 310. Controller 306 translates referenced addresses from host 302 to physical addresses in volatile memory 310 and MRAM 314.

Volatile memory 310 is a higher speed memory than MRAM 314 and is used to temporarily hold those portions of the contents of MRAM 314 that are anticipated will be used in the near future by host 302. Volatile memory 310 may shorten the time necessary for host 302 to perform memory accesses, either for data or instructions. The information located in volatile memory 310 can be accessed in less time than information located in MRAM 314. Thus, host 302 accessing volatile memory 310 may spend less time waiting for instructions and data to be fetched and/or stored.

Volatile memory 310 is a memory that is free of defects, and may comprise an SRAM, DRAM, or other suitable memory. MRAM 314 is similar to MRAM 50 illustrated in FIGS. 3-5 and previously described. A portion of MRAM 50 is designated by controller 306 as a page file. The page file holds pages of volatile memory 310 containing data and instructions being used by host 302. Controller 306 moves data and instructions back and forth between the page file in MRAM 50 and volatile memory 310 as the data and instructions are needed by host 302.

In operation, controller 306 comprises a virtual memory controller. During a read operation, host 302 sends a read request including a reference address to controller 306. Controller 306 determines if the requested data is in volatile memory 310. If the data is not in volatile memory 310, then a page fault occurs. Host 302 then fetches the requested page from MRAM 314. Host 302 performs error correction on the page and the page is placed into volatile memory 310. When a page of memory in volatile memory 310 is to be over-written, the page is read by host 302 and host 302 creates error correction redundancy information for the page. The page and redundancy information are copied by host 302 into MRAM 314. Error correction algorithms are implemented as software algorithms on host 302.

Since the price for a bit in MRAM 314 is less than the price for a bit in volatile memory 310, a system can be made to appear as though it has more memory at a lower cost. This is possible since MRAM 314 does not have integrated ECC and may be shared as both non-volatile storage (such as a hard-disk-drive) and as the virtual memory secondary store.

During a write operation, host 302 sends a write request including a reference address and data to controller 306. Controller 306 updates the referenced data in volatile memory 310. If the referenced data is found in MRAM 314, then it is written using controller 306. Writes to MRAM 314 are preceded by the generation of error correction redundancy information.

FIG. 8 is a flow diagram illustrating an exemplary embodiment of a method 400 for reading or writing information in MRAM virtual memory system 300. At 401, if a reset or power down condition exists, control passes to block 444. If a reset or power down condition does not exist, control passes to block 402. At 444, all pages in volatile memory are ECC encoded and written to MRAM 314. At 402, host 302 sends a memory read request or a memory write request to controller 306 including a reference address. At 404, controller 306 translates the reference address for the request to a physical address. At 406, controller 306 determines whether the request from host 302 is a memory read request or a memory write request.

If the request is a write request, at 426, controller 306 checks volatile memory 310 for the page containing the data. At 428, if the page containing the data to be updated is found in volatile memory 310, at 430, host 302 writes the data to volatile memory 310. If the page containing the data is not found in volatile memory 310, a page fault occurs at 432. At 434, the displaced page is ECC encoded and written from volatile memory to MRAM 314 by host 302. At 436, host 302 fetches the page from MRAM 314. At 438, host 302 performs ECC decoding on the page. At 440, host 302 places the page in volatile memory 310. At 442, host 302 writes the data to volatile memory 310.

If the memory request is a read request, at 408 controller 306 checks volatile memory 310 for the page containing the requested data. At 410, controller 306 determines whether the page is stored in volatile memory 310. If the requested page is stored in volatile memory 310, at 412, controller 306 provides the data to host 302 from volatile memory 310. If the requested page is not stored in volatile memory 310, a page fault occurs at 414. At 415, the displaced page is ECC encoded and written from volatile memory to MRAM 314 by host 302. At 416, host 302 fetches the page from MRAM 314. At 418, host 302 performs ECC decoding on the page. At 420, host 302 places the page in volatile memory 310. At 422, the requested data is provided to host 302.

1. A memory device comprising:
a magneto-resistive random access memory (MRAM);
a cache comprising a volatile memory; and
a decoder configured to translate referenced addresses to physical addresses to access data and pass the data between the MRAM and the cache and between the cache and a controller.

2. The memory device of claim 1, wherein the decoder translates referenced addresses from the controller to physical addresses in the MRAM and the cache.

3. The memory device of claim 1, further comprising:
an error detection and correction circuit electrically coupled to the cache and the MRAM, the error detection and correction circuit configured for error correction encoding and decoding of the data.

4. The memory device of claim 1, wherein the cache comprises static random access memory.

5. The memory device of claim 1, wherein the cache comprises dynamic random access memory.

6. The memory device of claim 1, wherein the cache, the MRAM, and the decoder are fabricated on a single semiconductor substrate.

7. The memory device of claim 1, wherein the cache comprises one of a unified cache and a segmented cache.

8. The memory device of claim 7, wherein the segmented cache comprises a data segment and an instructions segment.

9. A memory device comprising:
a magneto-resistive random access memory (MRAM);
a volatile memory; and
a virtual memory controller configured to pass data between the MRAM, the volatile memory, and a host.

10. The memory device of claim 9, wherein the controller passes data between the volatile memory and the host based upon requests from the host.

11. The memory device of claim 9, wherein the volatile memory comprises a static random access memory.

12. The memory device of claim 9, wherein the volatile memory comprises a dynamic random access memory.

13. The memory device of claim 9, wherein a portion of the MRAM comprises a page file.

14. A method for reading data or instructions from a memory device that comprises a magneto-resistive random access memory (MRAM) coupled to a cache comprising:
receiving a request from a controller to read data from the MRAM;
determining if the requested data is located in the cache;
passing the data from the MRAM to the cache if the data is not located in the cache; and
passing the data to the controller from the cache.

15. The method of claim 14, further comprising:
error correction decoding the data from the MRAM.

16. The method of claim 14, wherein the request comprises reference addresses, the method further comprising:
translating the reference addresses to physical addresses.

17. A method for writing data to a memory device that comprises magneto-resistive random access memory (MRAM) coupled to a cache comprising:
receiving a request from a controller to write data to the MRAM;
determining if a memory block where the data is to be stored is located in the cache;
passing the memory block from the MRAM to the cache if the memory block is not located in the cache;
passing the data from the controller to the cache; and
passing the data from the cache to the MRAM.

18. The method of claim 17, further comprising:
error correction encoding the data from the cache.

19. The method of claim 17, wherein the request comprises reference addresses, the method further comprising:
translating the reference addresses to physical addresses.

20. A portable electronic device comprising:
a processor; and
a semiconductor memory device comprising:
a magneto-resistive random access memory (MRAM);
a cache comprising a volatile memory; and
a control and address decoder configured to control the passing of data between the MRAM and the cache and between the cache and the processor.

21. The portable electronic device of claim 20, wherein the portable electronic device comprises a display.

22. The portable electronic device of claim 20, wherein the portable electronic device is one of a personal digital assistant, a cellular telephone, a digital music player, a personal organizer, and a digital camera.
